(19) United States
(12) Patent Application Publication
(10) Pub. No.: US 2014/0339752 A1
(43) Pub. Date: Nov. 20, 2014

(54) PIPE AND TUBING ASSEMBLY WORKSTATION

(71) Applicants: Raymond A. Lanne, Middle Grove, NY (US); Richard A. Lanne, Granville, NY (US)

(72) Inventors: Raymond A. Lanne, Middle Grove, NY (US); Richard A. Lanne, Granville, NY (US)

(21) Appl. No.: 14/281,413

(22) Filed: May 19, 2014

Related U.S. Application Data
(60) Provisional application No. 61/824,385, filed on May 17, 2013.

(51) Int. Cl. B25B 11/02

(52) U.S. Cl. CPC B25B 11/02
USPC 269/45

(57) ABSTRACT

A tubing assembly system including a first platform and a second platform of different heights. The first and second platforms are configured to attach to a tube securement device for maintaining centerline alignment between tubular members of different sizes. The system may also include a work surface having multiple holes for securing the platforms.

### FIELD OF THE INVENTION

The present invention relates generally to a workstation for assembling pipes and other types of tubular members. More specifically, the invention relates to a workstation having a number of jigs that can easily and rapidly be modified for maintaining centerline alignment between tubular members of different diameters.

### BACKGROUND OF THE INVENTION

Workbenches, workstations, tables and similar types of apparatus are systems commonly used to aid in the assembly of tubular members such as ferrous and non-ferrous pipe, PVC tubing, plastic tubing, vinyl tubing and related fittings. These systems, which will be referred to herein as “workstations”, commonly utilize jigs for cradling and securing tubing so that fittings can be secured to the ends of tubing segments. V-blocks are one example of securement devices commonly used for this purpose. Vices, clamps and other components for securing tubular members need to be oriented and configured so that the centerlines of tubular member are brought into alignment, providing optimal positioning for assembling and coupling tubular members and respective fittings. Once the tubes are in alignment, the user can then weld, fuse, solder, glue, seal or otherwise attach and couple together tubular members and related fittings. Workstation components can also secure tubing that lies along the same plane. and additionally, components have been designed to secure tubing that extends out of plane with other tubular members. So for example, a raised support apparatus consisting of a clamp that is slidable up and down along a vertical rod positioned on the workstation surface can be used to support tubular members extending out of plane.

When coupling tubing components of a common diameter, centerline alignment is usually straightforward, since workstation components will commonly have the same dimensions. So for example, when joining two ½ inch tubular members into a coupling, centerline alignment can easily be established by taking two v-blocks of the same dimension, placing them on a flat work surface, and securing each ½ inch tubular member in a respective v-block. Since the tubes and v-blocks have the same dimensions, and the v-blocks are resting on a flat surface, the centerlines of each tubular member will automatically Re within a common plane and align with one another. However, tubing assemblies often require the coupling of tubing members having different diameters. As illustrated in FIGS. 1 and 2, one tubular member 10 has a smaller diameter than the other tubular member 20, and a problem arises as centerlines are out of alignment for coupling to a fitting, such as a pipe reducing fitting. When a user secures the tubular members into a standard set of v-blocks 30, 40 having the same dimensional geometry, and places the v-blocks on a standard flat work surface, the centerlines 12, 22 lie along different planes and are out of alignment, as illustrated in FIG. 2.

Workstation components have been proposed for addressing centerlines that fail out of alignment due to variable pipe diameters, including the use of shims to raise the resting height of the tube on the securement device, or jigs that have moving mechanical components for adjusting the resting height of a tube, but these solutions can be problematic. For instance, shims can be unstable, and may otherwise require special modification to a standard v-block for maintaining stability. Shims may also prove to be difficult in providing accurate alignment of centerlines, and may require excessive troubleshooting before obtaining proper centerline alignment. Adjustable securement devices having moving mechanical components can also be problematic. For instance, U.S. Pat. No. 7,043,851 to Le describes an adjustable v-block having a slidably adjustable section for changing the resting height of a tubular member and U.S. Pat. No. 3325,162 to Lukas describes an adjustable v-block having an adjustable v-block that that can be lowered or raised using a threaded component. A pitfall of systems like the one described in Le is that the east/west centerline alignment shifts as the height is adjusted, which requires realignment of the entire block as the proper height is being troubleshooted. Regarding mechanically adjustable systems in general, mechanical failure of the movable components could render adjustable systems inoperable. Further, as mechanical parts ware over time, the resting height may become inaccurate, throwing off centerline alignment, especially when coupling small diameter tubing. In addition, securement devices such as v-blocks having movable mechanical height adjustment components are more expensive to manufacture, and tend to be less durable and stable in comparison to standard v-blocks manufactured as a unitary structure.

There remains a need for an improved pipe and tube assembly workstation that can accommodate tubular members having different diameters, can easily be modified by a user to maintain centerline alignment, is compatible with standard v-blocks and securement devices, provides high performance in the areas of stability and durability, and can be manufactured at a low cost.

### SUMMARY OF THE INVENTION

In one aspect, the invention is a tubing assembly system having a first platform having a first top surface, a first bottom surface and a first height extending between the first top surface and the first bottom surface, and a second platform comprising a second top surface, a second bottom surface and a second height extending between the second top surface and the second bottom surface. The first and second platforms are configured to attach to a tube securement device, and the first height is different from the second height.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1 is a perspective view of a prior art tube fitting workstation;

FIG. 2 is a cross-sectional end view of the prior art tube fitting workstation shown in FIG. 1, illustrating the misalignment of centerlines;

FIG. 3 is a perspective vie of the workstation shown in FIG. 3, illustrating alignment of centerlines;

FIG. 4 is a side view of a platform and a tube securement device according to an embodiment of the invention;

FIG. 5 is a top view of work surface according to an embodiment of the invention;

FIG. 6 is a perspective view of a tubing assembly secured by a workstation having a tower according to an embodiment of the invention.

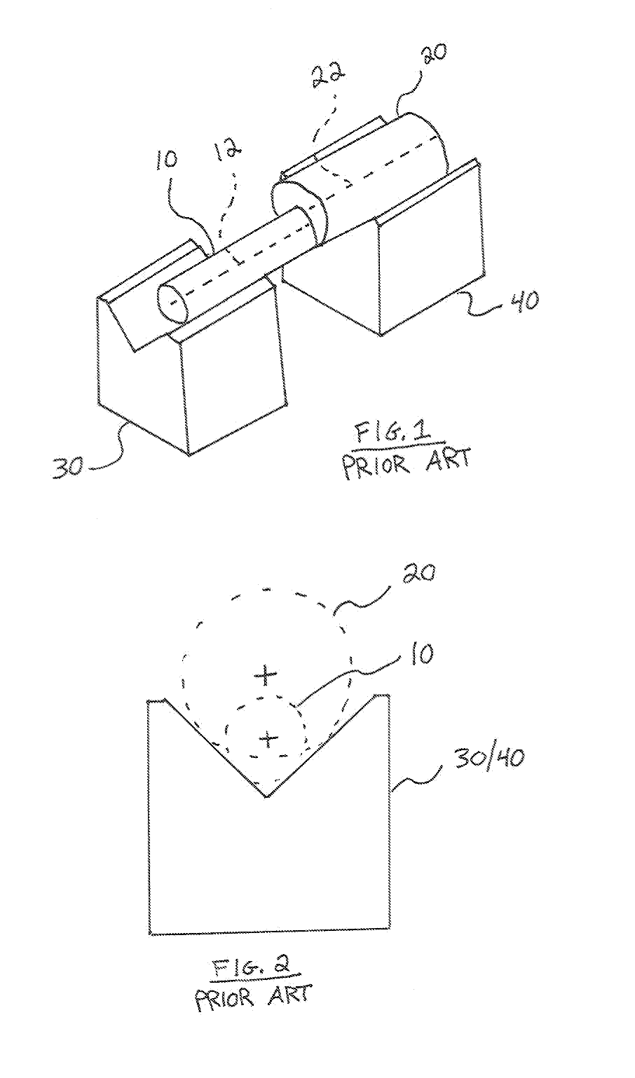

### DETAILED DESCRIPTION OF THE INVENTION

The present invention can be understood more readily by reference to the following detailed description, the examples included therein and to the Figures and their following description. The drawings, which are not necessarily to scale, depict selected preferred embodiments and are not intended to limit the scope of the invention. The detailed description illustrates by way of example, not by way of limitation, the principles of the invention. The skilled artisan will readily appreciate that the devices and methods described herein are merely examples and that variations can be made without departing from the spirit and scope of the invention. It is also to be understood that the terminology used herein is for the purpose of describing particular embodiments only and is not intended to be limiting.

Referring now in detail to the drawings, in which like reference numerals indicate like parts or elements throughout the several views, in various embodiment presented herein is a pipe and tube assembly workstation.

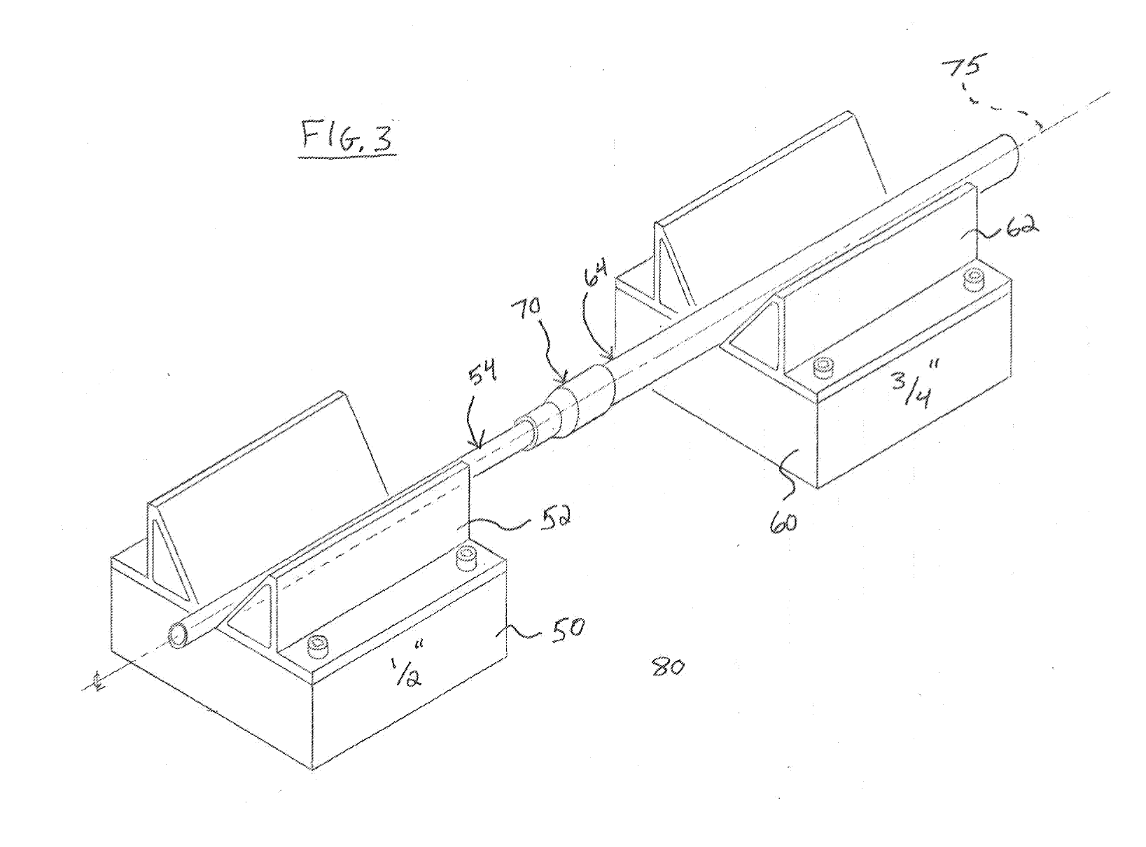

As shown in FIG. 3, an embodiment of the workstation includes a first v-block 52 mounted on top of a first platform 50, and a second v-block 62 mounted on top of a second platform 60. The first v-block 52 secures a first tubular member 54 within the concave surfaces of the v-block 52 via the first clamping member 56. The v-block and clamping members are known in the art, and comprise a toggle clamp for interfacing a rubber stop with the outer surface of a tubular member as shown. The first v-block 52 and the second v-block 62 have the same geometric dimensions. The second v-block 62 secures the second tubular member 64 within the concave surfaces of the v-block 62 via the second clamping member 66. The first tubular member 54 is a ½ inch segment of pipe, and the second tubular member 64 is a ¾ inch segment of pipe. The first and second tubular members 54, 64 are coupled to a pipe reducing fitting 70.

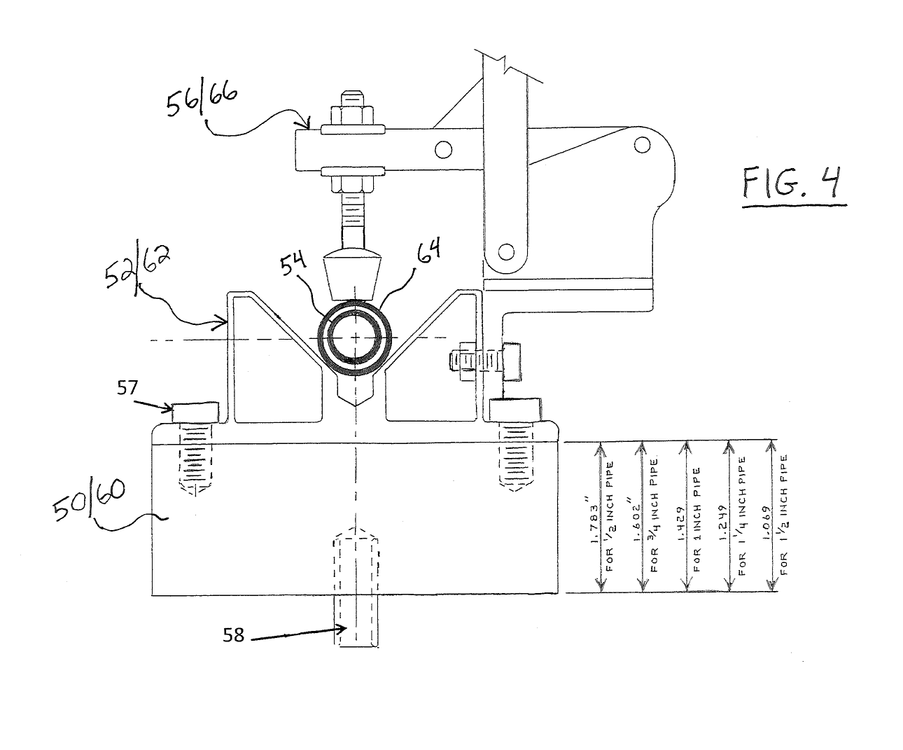

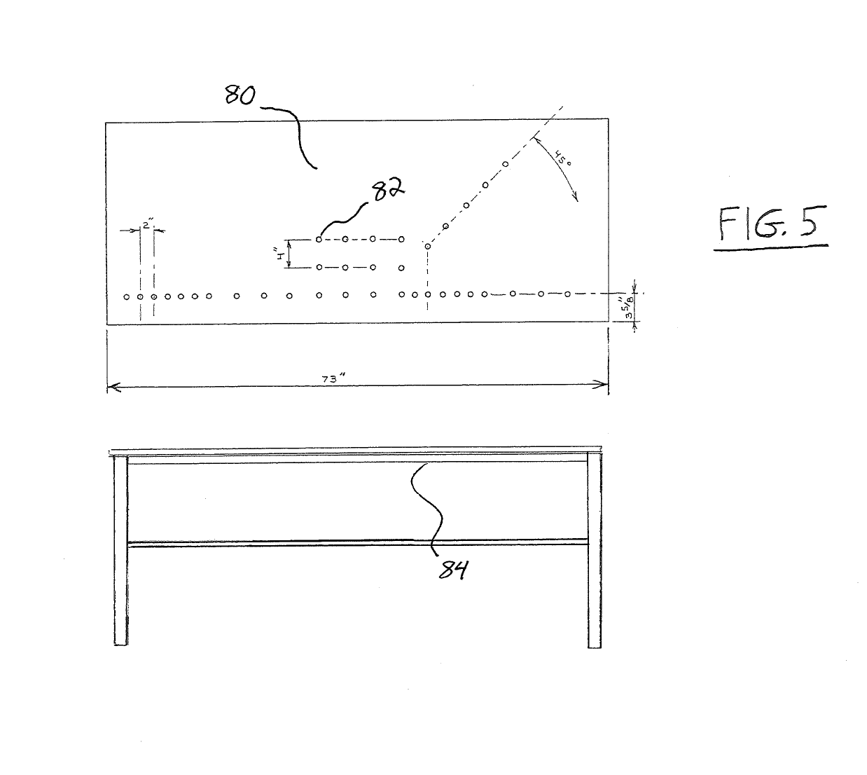

According to embodiments of the invention, the workstation includes number of platforms that are manufactured with specific predetermined heights so that standard pipe fitting securement devices such as the v-blocks shown can mount on top of the corresponding platform, and centerline alignment can be maintained. As shown in FIG. 3, the height of the first platform 50 is taller than the height of the second platform 60. The offset heights of the first and second platforms 50, 60 maintains accurate alignment of the centerline 75 between the ½ inch and ¾ inch pipe segments, despite the use of standard and unmodified v-blocks 52, 62 of identical dimensions. Each platform included with the workstation is labeled and corresponds to a particular tube diameter for maintaining centerlines along a common plane. Therefore, the system allows the user to utilize standard off-the-shelf securement devices and maintain centerline alignment by simply selecting a platform according to the diameter of the pipe being used. As shown in the embodiment of FIG. 4, platforms can be manufactured at the following heights for corresponding pipe diameters: 1.783 inches for ½ inch pipe, 1.602 inches for ¾ inch pipe, 1.429 inches for 1 inch pipe, 1,249 inches for 1¼ inch pipe, and 1.069 inches for 1½ inch pipe. For mounting purposes, the top of the platforms can include threaded holes and screws 58 for mounting a securement device such as a v-block to the platform. In alternative embodiments of the invention, stackable platform plates of a predetermined height (e.g. ¼ inch) can be provided for customizing a platform height.

The bottom of each platform can include one or more dowel shaped pins 58 protruding from the bottom surface. The pin 58 is sized to be compatible with holes in a work surface that can be included as a component of the workstation. Platforms can include one pin centered at the bottom surface of the platform so that the platform can rotate about the axis of the pin, facilitating easy setup for angled tube assembly arrangements. Platforms can also include multiple pins for dedicated linear and/or angled arrangements. In an alternative embodiment, pins can be recessed and spring tensioned within the base of the platform. A pin housing can be formed above the pin for accommodating the pin in recessed position. The arrangement of recessed pins can be customized so that the user can deploy pins in specific combinations (provided with instructions for the workstation) that will only allow the platform to mate with the work surface 80 at specific angles, thus providing a mechanism for a user angling system. Platforms do not necessarily have to include a in for interfacing with the work surface 80. Floating platforms having a contiguous bottom surface can also be provided. Alternatively, platforms can be manufactured with removable pins or recessed pin housings.

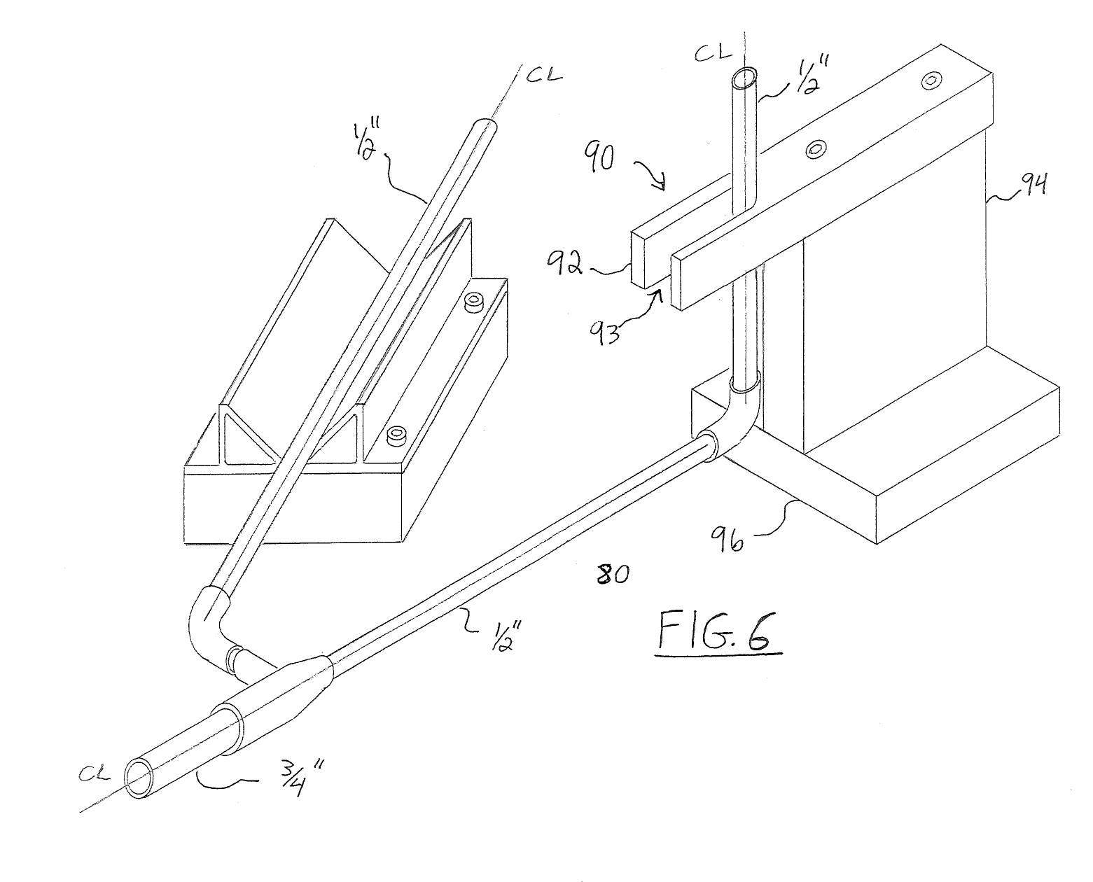

As shown in FIG. 5, the work surface 80 can include an array of holes 82 arranged in a grid-like fashion and sized to accept the pins so that the platforms can remain stabilized during tube assembly. In a preferred embodiment shown in FIG. 5, the work surface 80 includes an array of holes 82 aligned linearly in a row across a bottom portion of the surface, and an array of holes extending linearly away from and assuming an angle with the bottom row. Angled rows can assume angles with the bottom row commonly found in tube fitting assemblies, such as 45 degrees. Spacing between holes can correspond to spacing increments between pins on platforms for proper interfacing between the platform and the work surface. Work surfaces, platforms and other components can be made out of durable rigid materials known in the art, such as metals, for example, aluminum. The work surface 80 can be attached to or integrally formed into an industrial grade table 84.

Tubing assemblies will often require aligning tubes of variable diameters where centerlines lie along the same plane (i.e. a plane parallel to the work surface). Embodiments of the invention can also include a support having a U-shaped opening for stabilizing tubes that extend out into the third dimension, i.e. out of plane with the rest of the tubing and away from the work surface. As shown in FIG. 6, the tower 90 has a tube securement element 92, a riser 94 and a base 96. The tube securement element 92 can be removable from the riser 94, and the riser 94 can be removable from the base 96. Alternatively, one or more components can be formed as a unitary piece. The tube securement element 92 has a U-shaped opening 93 for accepting and stabilizing tubes of various diameters. The bottom of the support can feature one or more pins protruding from its bottom surface, so that the tower is compatible with the methods described above for interfacing with the work surface 80. An assortment of interchangeable securement elements, towers and bases can be supplied with the workstation so that a user can customize the support based on the specifications of their tube assembly.

An example of a pipe assembly assembled on a workstation according to an embodiment of the present invention is as follows. A platform supporting a v-block securing ½ inch pipe segment and a platform supporting a v-block securing a ¾ inch pipe segment are aligned and interfaced with holes spanning across the bottom of the work surface. These segments are linearly aligned with one another, and share a common centerline. An additional platform supports a v-block securing a ½ inch pipe segment, and is interfaced with holes in the work surface extending out at an angle of 45 degrees with respect to the linearly aligned segments described above. According to the present invention, the platforms maintain all centerlines within a common plane, and can accommodate variations in pipe size and angled assemblies. For pipe segments that extend away from the common plane, a tower can be used to stabilize the segment. and as described above, the tower can be customized to secure pipes of various sizes.

What is claimed is:

1. A tubing assembly system comprising:
a first platform comprising a first top surface, a first bottom surface and a first height extending between the first top surface and the first bottom surface; and
a second platform comprising a second to p surface, a second bottom surface and a second height extending between the second top surface and the second bottom surface;
wherein the first and second platforms are configured to attach to a tube securement device, and
wherein the first height is different from the second height.

2. The tubing assembly system of claim 1 further comprising:
a work surface comprising a plurality of holes.

3. The tubing assembly system of claim 2, wherein the work surface comprises a plurality of holes arranged in a first linear configuration.

4. The tubing assembly system of claim 3, wherein the work surface comprises a plurality of holes arranged in a second linear configuration which assumes an angle of 45 degrees with the first linear configuration.

5. The tubing assembly of claim 2 further comprising:
a first pin extending out from the first bottom surface, wherein the second pin is configured to interface with at least one of the plurality of holes.

6. The tubing assembly of claim 5 further comprising:
a second pin extending out from the first bottom surface, wherein the second pi s configured to interface with at least one of the plurality of holes.

7. The tubing assembly of claim 6, wherein the first and second pin are set at a predetermined distance from each other, and wherein the predetermined distance corresponds to a predetermined distance of at least two of the plurality of holes.

8. The tubing assembly of claim 1 further comprising:
a third platform comprising a riser and a tube securement component having U-shaped opening, wherein the riser has a riser height greater than the first and second height.

9. The tubing assembly system of claim 1, wherein the tube securement device is a v-block.
